(19) United States
(12) Patent Application Publication
(10) Pub. No.: US 2013/0162508 A1
(43) Pub. Date: Jun. 27, 2013

(54) Driving Circuit of a Liquid Crystal Panel and an LCD

(71) Applicants: Shiqi Li, Shenzhen (CN); Shihchyn Lin, Shenzhen (CN)

(72) Inventors: Shiqi Li, Shenzhen (CN); Shihchyn Lin, Shenzhen (CN)

(73) Assignee: SHENZHEN CHINA STAR OPTOELECTRONICS TECHNOLOGY CO., LTD., Shenzhen (CN)

(21) Appl. No.: 13/381,344

(22) PCT Filed: Dec. 26, 2011
(86) PCT No.: PCT/CN11/84645

§ 371 Date: Dec. 28, 2011

(30) Foreign Application Priority Data
Dec. 21, 2011 (CN) 201110433177.7

(51) Int. Cl. G09G 3/36

(52) U.S. Cl. 345/92

(57) ABSTRACT

A driving circuit for use in an LCD is proposed. The driving circuit includes a first clock signal input, a second clock signal input, a first TFT, and a controlling terminal. The controlling terminal is connected to a gate of the first TFT. The first TFT is placed between the controlling terminal and the first clock signal input. The controlling terminal is placed between the first TFT and the second clock signal input. A parasite capacitor is formed in the first TFT. The driving circuit further includes a suppression capacitor placed between the second clock signal input and the controlling terminal. The suppression capacitor is used for adjusting a potential of the controlling terminal in response to transitions of the first clock signal and the second clock signal. The present invention provides a simplified layout, occupies less side area of the LCD, and upgrades image quality of the LCD.

### BACKGROUND OF THE INVENTION

1. Field of the Invention

The present invention relates to liquid crystal display (LCD) technology, and more particularly, to a driving circuit of a liquid crystal (LC) panel and an LCD.

2. Description of the Prior Art

With the development of LCD technology, a growing demand for high quality components inside the LCD panel is seen.

Each pixel in an active-matrix liquid crystal display (AMLCD) comprises a thin-film transistor (TFT). A gate of the TFT is connected to a scan line, and a drain or source of the TFT is connected to a data line.

High voltage is applied to the scan line (the gate), causing the TFT to be turned on. Grayscale voltage from the data line (source/drain) is applied to the LC layer through a transparent pixel electrode (drain/source). The grayscale voltage changes the alignment of the LCs in the LC layer, causing the predetermined grayscale to be shown.

Enough positive voltage is applied to a scan line, enabling all of the TFTs on the scan line to be turned on. So a pixel electrode corresponding to the scan line is connected to a data line. Then, signal voltage carried by the data line is applied to the pixel and to a corresponding LC layer through the pixel electrode. Accordingly, the alignment of LCs is altered, achieving the goal of showing various colors. The driving circuit used for supplying voltage to scan lines in the conventional technology is formed by a driving chip attached to the LCD panel externally. The cost of the driving chip used in the conventional technology is high; in addition, it takes more time to attach the driving chip to the LCD panel during the process.

Gate driver ICs are formed on an array substrate in a gate driver on array (GOA) circuit. A well designed GOA circuit effectively reduces the size of the LCD panel, making the LCD panel thinner.

Referring to FIG. 1, FIG. 1 is a block diagram showing the structure of the conventional GOA circuit. The GOA circuit comprises a first clock signal input 11, a first TFT 12, a second TFT 13, a third TFT 14, a fourth TFT 15, a controlling terminal 16, a first pull-down circuit 17, and a second pull-down circuit 17.

The first TFT 12 is larger in size and its parasite capacitor (not shown) becomes larger accordingly. The coupling of the parasite capacitor inside the first TFT 12 causes the potential of the controlling terminal 16 (i.e., node) to be raised (or to be lowered) in response to a transition of the first clock signal from low potential to high potential (or from high potential to low potential). The gate of the first TFT 12 will be turned on once the potential of the controlling terminal 16 is raised to a certain level. Then, current leakage from the first TFT 12 may cause the gate of the first TFT 12 to output abnormal voltage at high potential to the scan line Gn, thereby displaying images abnormally.

To solve the above-mentioned problems, alternate operations of the first pull-down circuit 17 and the second pull-down circuit 18 is to lower the potential of the controlling terminal 16 to avoid an abnormal output of the gate of the first TFT 12 in the conventional technology. Either the first pull-down circuit 17 or the second pull-down circuit 18 is composed of multiple TFTs. The use of the first pull-down circuit 17 and the second pull-down circuit 18 occupies larger side area of the LCD and needs more complexity layout. Moreover, current leakage of the two pull-down circuits may occur as the characteristic of the TFT is varied, degrading displaying quality of the LCD panel.

### SUMMARY OF THE INVENTION

The present invention is to provide a driving circuit of the LCD panel for solving problems that the pull-down circuits having multiple TFTs occupies larger side area of the LCD and needs more complexity layout. The present invention also solve the conventional problem that current leakage of the two pull-down circuits occur as the characteristic of the TFT is varied, which degrades displaying quality of the LCD panel.

According to the present invention, a driving circuit of a liquid crystal display (LCD) panel, comprising a first clock signal input for inputting a first clock signal, a first thin film transistor (TFT), a controlling terminal coupled to a gate of the first TFT, the first TFT being placed between the controlling terminal and the first clock signal input. The driving circuit of the LCD panel further comprises a second clock signal input for inputting a second clock signal, and a suppression capacitor between the second clock signal input and the controlling terminal, and the controlling terminal is placed between the first TFT and the second clock signal input, the first clock signal input being connected to a source or drain of the first TFT. The first clock signal has a first high potential and a first low potential, the second clock signal has a second high potential and a second low potential, and the first and second clock signals have the same duty cycle. The first clock signal is inversed to the second clock signal, and the suppression capacitor is used for adjusting a potential of the controlling terminal in response to transitions of the first clock signal and the second clock signal.

In one aspect of the present invention, within a period, the transition of the first clock signal from the first high potential to the first low potential, and the transition of the second clock signal from the second low potential to the second high potential; or the transition of the first clock signal from the first low potential to the first high potential, and the transition of the second clock signal from the second high potential to the second low potential.

In another aspect of the present invention, the driving circuit of the LCD panel further comprises a second TFT, a third TFT, and a fourth TFT, and the second, third, and fourth TFTs all are connected to the controlling terminal.

According to the present invention, a driving circuit of a liquid crystal display (LCD) panel, comprising a first clock signal input for inputting a first clock signal, a first thin film transistor (TFT), a controlling terminal coupled to a gate of the first TFT, the first TFT being placed between the controlling terminal and the first clock signal input. The driving circuit of the LCD panel further comprises a second clock signal input for inputting a second clock signal, and a suppression capacitor between the second clock signal input and the controlling terminal, and the controlling terminal is placed between the first TFT and the second clock signal input. The first clock signal is inversed to the second clock signal, and the suppression capacitor is used for adjusting a potential of the controlling terminal in response to transitions of the first clock signal and the second clock signal.

In one aspect of the present invention, the first clock signal input is connected to a source or drain of the first TFT.

In another aspect of the present invention, the first clock signal has a first high potential and a first low potential, the second clock signal has a second high potential and a second low potential, and the first and second clock signals have the same duty cycle.

In further another aspect of the present invention, within a period, the transition of the first clock signal from the first high potential to the first low potential, and the transition of the second clock signal from the second low potential to the second high potential; or the transition of the first clock signal from the first low potential to the first high potential, and the transition of the second clock signal from the second high potential to the second low potential.

In yet another aspect of the present invention, the driving circuit of the LCD panel further comprises a second TFT, a third TFT, and a fourth TFT, and the second, third, and fourth TFTs all are connected to the controlling terminal.

According to the present invention, a liquid crystal display (LCD),comprises a driving circuit of an LCD panel which comprises a first clock signal input for inputting a first clock signal, a first thin film transistor (TFT), a controlling terminal coupled to a gate of the first TFT, the first TFT being placed between the controlling terminal and the first clock signal input; the driving circuit further comprises a second clock signal input for inputting a second clock signal, and a suppression capacitor between the second clock signal input and the controlling terminal, and the controlling terminal is placed between the first TFT and the second clock signal input. The first clock signal is inversed to the second clock signal, and the suppression capacitor is used for adjusting a potential of the controlling terminal in response to transitions of the first clock signal and the second clock signal. The first clock signal input is connected to a source or drain of the first TFT.

In one aspect of the present invention, the first clock signal input is connected to a source or drain of the first TFT.

In another aspect of the present invention, the first clock signal has a first high potential and a first low potential, the second clock signal has a second high potential and a second low potential, and the first and second clock signals have the same duty cycle.

In further another aspect of the present invention, within a period, the transition of the first clock signal from the first high potential to the first low potential, and the transition of the second clock signal from the second low potential to the second high potential; or the transition of the first clock signal from the first low potential to the first high potential, and the transition of the second clock signal from the second high potential to the second low potential.

In yet another aspect of the present invention, the driving circuit of the LCD panel further comprises a second TFT, a third TFT, and a fourth TFT, and the second, third, and fourth TFTs all are connected to the controlling terminal.

Contrast to the prior art, a suppression capacitor is placed between the second clock signal input and the controlling terminal. The suppression capacitor is used for lowering (or raising) the potential of the controlling terminal in response to a transition of the first clock signal from low potential to high potential and a transition of the second clock signal from high potential to low potential. It is unnecessary to use the pull-down circuits with a plurality of TFTs to lower the potential of the controlling terminal. As can be seen, the prevent invention has advantages of a simple layout, occupying less side area of the LCD, an avoidance of current leakage resulting from the variation characteristic of the TFT, and an improvement of image quality of the LCD.

These and other features, aspects and advantages of the present disclosure will become understood with reference to the following description, appended claims and accompanying figures.

### BRIEF DESCRIPTION OF THE DRAWINGS

FIG. 1 is a block diagram showing the structure of the conventional GOA circuit.

FIG. 2 is a circuit diagram of a driving circuit of the LCD panel according to a preferred embodiment of the present invention.

FIG. 3 showing a block diagram of the driving circuit of LCD panel according to the second embodiment of the present invention.

FIG. 4 shows an equivalent circuit of the driving circuit in FIG. 2.

FIG. 5 shows a timing diagram of the first clock signal and the second clock signal according to the preferred embodiment of the present invention.

### DETAILED DESCRIPTION OF THE PREFERRED EMBODIMENTS

In all figures, units of similar structure are labeled with the same numbers.

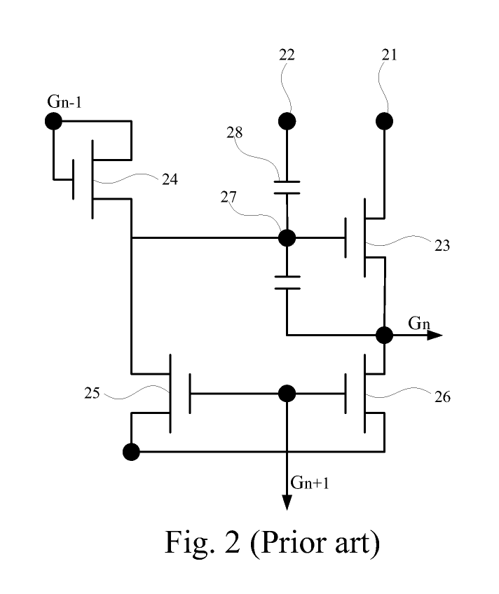

Referring to FIG. 2, FIG. 2 is a circuit diagram of a driving circuit of the LCD panel according to a preferred embodiment of the present invention.

The driving circuit of the LCD panel comprises a first clock signal input 21, a second clock signal input 22, a first TFT 23, a second TFT 24, a third TFT 25, a fourth TFT 26, a controlling terminal 27, and a suppression capacitor 28.

The first clock signal input 21 is connected to a source or drain (not shown) of the first TFT 23. The second clock signal input 22 is connected to the controlling terminal 27. The suppression capacitor 28 is placed between the second clock signal input 22 and the controlling terminal 27.

The controlling terminal 27 is connected to a gate (not shown) of the first TFT 23. The controlling terminal 27 is connected to the second TFT 24, the third TFT 25, and the fourth TFT 26.

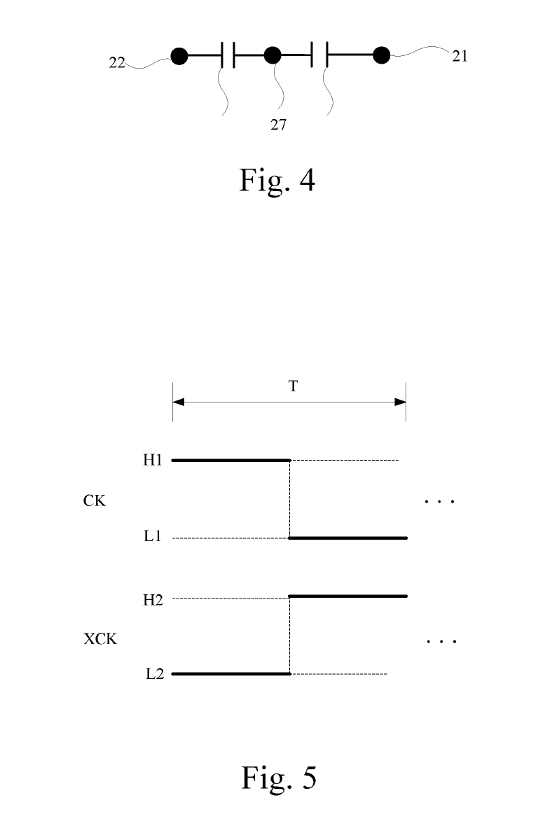

Referring to FIG. 4, FIG. 4 shows an equivalent circuit of the driving circuit in FIG. 2. An inherent parasite capacitor 231 exists in the first TFT 23. The parasite capacitor 231 is coupled between the first clock signal input 21 and the controlling terminal 27. As described above and as shown in FIG. 2, the controlling terminal 27 is placed between the parasite capacitor 231 and the suppression capacitor 28.

In practical application, the first clock signal input 21 is used for supplying a first clock signal having first high potential and first low potential; the second clock signal input 22 is used for supplying a second clock signal having second high potential and second low potential.

The first clock signal input 21 and the second clock signal input 22 input the first and second clock signals within the same period. The first clock signal input 21 and the second clock signal input 22 alternately supply the first and second clock signals at high and low potentials in turns within the same period.

Please refer to FIG. 5, FIG. 5 shows a timing diagram of the first clock signal and the second clock signal according to the preferred embodiment of the present invention. During the period T, while the first clock signal input 21 inputs the first clock signal CK at first high potential H1, the second clock signal input 22 inputs the second clock signal XCK at second low potential L2; while the first clock signal input 21 inputs the first clock signal CK at first low potential L1, the second clock signal input 22 inputs the second clock signal XCK at second high potential H2.

The operation principle of the driving circuit of the LCD panel in the preferred embodiment of the present invention is described as follows:

A transition of the first clock signal CK from the first high potential H1 to the first low potential L1 and a transition of the second clock signal XCK from the second low potential L2 to the second high potential H2 occur at the same moment.

The potential of the controlling terminal 27 is raised in response to the transition of the first clock signal CK from the first high potential H1 to the first low potential L1, due to a coupling effect of the parasite capacitor 231 with greater capacitance in the first TFT 23. Meanwhile, the potential of the controlling terminal 27 is lowered in response to the transition of the second clock signal XCK from the second low potential L2 to the second high potential H2 due to the coupling effect of the suppression capacitor 28.

Conversely, the potential of the controlling terminal 27 is lowered in response to a transition of the first clock signal CK from the first low potential L1 to the first high potential H1, while the potential of the controlling terminal 27 is raised in response to the transition of the second clock signal XCK from the second high potential H2 to the second low potential L2 which is inversed to the transition of the first clock signal CK, due to the coupling effect of the suppression capacitor 28.

Obviously, the potential of the controlling terminal 27 maintains stable, making sure that voltage applied to the scan line Gn is stable because of the offset of the potential of the controlling terminal 27 lowered by the suppression capacitor 28 and the potential of the controlling terminal 27 raised owing to the coupling of the parasite capacitor 231. As can be seen, the prevent invention has advantages of a simple layout, occupying less side area of the LCD, an avoidance of current leakage resulting from the variation characteristic of the TFT, and an improvement of image quality of the LCD.

As shown in FIG. 5, preferably, the first high potential H1 of the first clock signal CK is applied in a 50% duty cycle of the period T and the first low potential L1 of the first clock signal CK is applied in another 50% duty cycle of the period T. Also, the second high potential H2 of the second clock signal XCK is applied in a 50% duty cycle of the period T and the second low potential L2 of the second clock signal XCK is applied in another 50% duty cycle of the period T. In this case, the first clock signal is inversed to the second clock signal. In another embodiment, the first clock signal and the second clock signal can have different duty cycles. For example, the first low potential L1 of the first clock signal CK and the second low potential L2 of the second clock signal XCK are applied in a 60% duty cycle of the period T, while the first high potential H1 of the first clock signal CK and the second high potential H2 of the second clock signal XCK are applied in a 40% duty cycle of the period T. Despite the first clock signal CK and the second clock signal XCK are a synchronous, the potential of the controlling terminal 27 is still suppressed by the coupling effects of the parasitic capacitor 231 and the suppression capacitor 28.

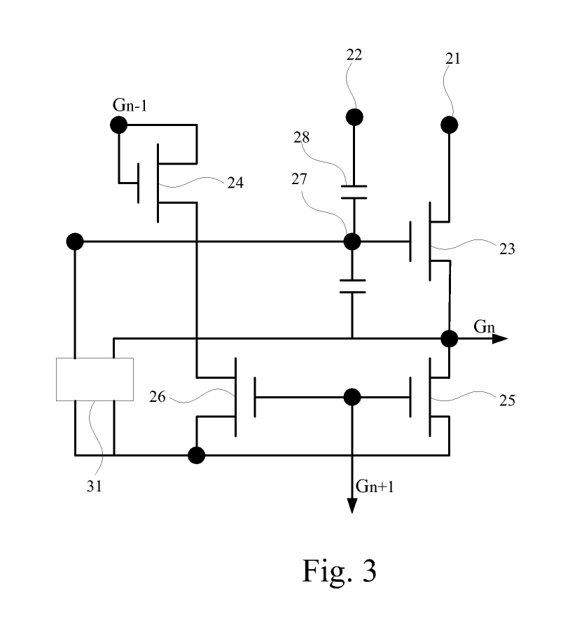

Please refer to FIG. 3 showing a block diagram of the driving circuit of LCD panel according to the second embodiment of the present invention. Differing from FIG. 2, a pull-down circuit 31 is added in the second embodiment.

In practical application, the potential of the controlling terminal 27 is raised in response to the transition of the first clock signal CK from the first high potential H1 to the first low potential L1. Meanwhile, the potential of the controlling terminal 27 is lowered due to the coupling effects of the pull-down circuit 31 and the suppression capacitor 28.

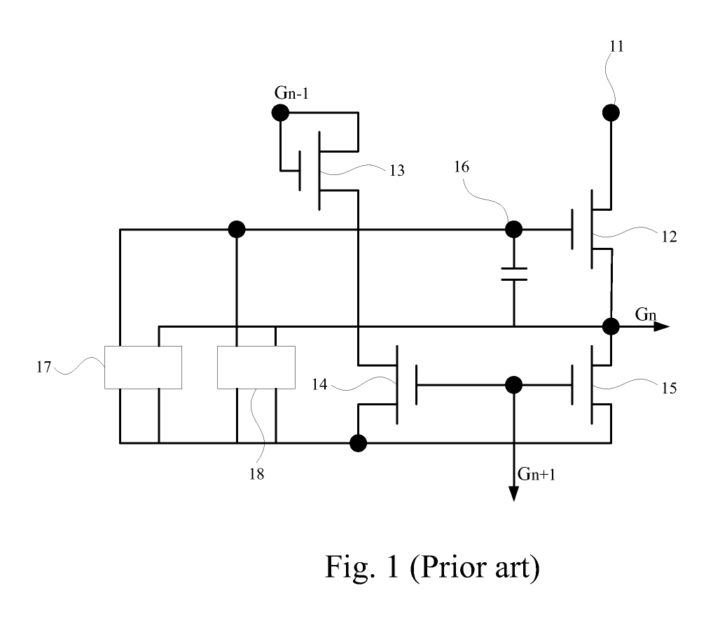

In contrast to the first pull-down circuit 17 and the second pull-down circuit 18 shown in FIG. 1, the second embodiment proposes that the potential of the controlling terminal 27 is raised in response to the transition of the first clock signal CK from the first high potential H1 to the first low potential L1, due to the coupling effects of the pull-down circuit 31 and the suppression capacitor 28. Obviously, the second embodiment provides a simplified layout and thus occupies less side area of the LCD. Because the operation of the second embodiment shown in FIG. 3 is similar to that of the first embodiment, it should be unnecessary to be explained in more detail.

The present invention further provides an LCD comprising the driving circuit of the LCD panel of the present invention. Since the driving circuit is fully elaborated, it should be unnecessary to be explained in more detail.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A driving circuit of a liquid crystal display (LCD) panel, comprising a first clock signal input for inputting a first clock signal, a first thin film transistor (TFT) connected to the first clock signal input, a controlling terminal coupled to a gate of the first TFT, wherein the driving circuit of the LCD panel further comprises a second clock signal input for inputting a second clock signal, and a suppression capacitor between the second clock signal input and the controlling terminal, and the controlling terminal is placed between the first TFT and the second clock signal input, the first clock signal input being connected to a source or drain of the first TFT;
the first clock signal has a first high potential and a first low potential, the second clock signal has a second high potential and a second low potential, and the first and second clock signals have the same duty cycle;
the first clock signal is inversed to the second clock signal, and the suppression capacitor is used for adjusting a potential of the controlling terminal in response to transitions of the first clock signal and the second clock signal.

2. The driving circuit of the LCD panel of claim 1, wherein within a period, the transition of the first clock signal from the first high potential to the first low potential, and the transition of the second clock signal from the second low potential to the second high potential; or the transition of the first clock signal from the first low potential to the first high potential, and the transition of the second clock signal from the second high potential to the second low potential.

3. The driving circuit of the LCD panel of claim 1 further comprising a second TFT, a third TFT, and a fourth TFT, and the second, third, and fourth TFTs, all of which are connected to the controlling terminal.

4. A driving circuit of a liquid crystal display (LCD) panel, comprising a first clock signal input for inputting a first clock signal, a first thin film transistor (TFT) connected to the first clock signal input, a controlling terminal coupled to a gate of the first TFT, wherein the driving circuit of the LCD panel further comprises a second clock signal input for inputting a second clock signal, and a suppression capacitor between the second clock signal input and the controlling terminal, and the controlling terminal is placed between the first TFT and the second clock signal input;
the first clock signal is inversed to the second clock signal, and the suppression capacitor is used for adjusting a potential of the controlling terminal in response to transitions of the first clock signal and the second clock signal.

5. The driving circuit of the LCD panel of claim 4, wherein the first clock signal input is connected to a source or drain of the first TFT.

6. The driving circuit of the LCD panel of claim 4, wherein the first clock signal has a first high potential and a first low potential, the second clock signal has a second high potential and a second low potential, and the first and second clock signals have the same duty cycle.

7. The driving circuit of the LCD panel of claim 6, wherein within a period, the transition of the first clock signal from the first high potential to the first low potential, and the transition of the second clock signal from the second low potential to the second high potential; or the transition of the first clock signal from the first low potential to the first high potential, and the transition of the second clock signal from the second high potential to the second low potential.

8. The driving circuit of the LCD panel of claim 4, further comprising a second TFT, a third TFT, and a fourth TFT, and the second, third, and fourth TFTs, all of which are connected to the controlling terminal.

9. A liquid crystal display (LCD), comprising: a driving circuit of an LCD panel which comprises a first clock signal input for inputting a first clock signal, a first thin film transistor (TFT), a controlling terminal coupled to a gate of the first TFT, the first TFT being placed between the controlling terminal and the first clock signal input; the driving circuit further comprises a second clock signal input for inputting a second clock signal, and a suppression capacitor between the second clock signal input and the controlling terminal, and the controlling terminal is placed between the first TFT and the second clock signal input;
the first clock signal is inversed to the second clock signal, and the suppression capacitor is used for adjusting a potential of the controlling terminal in response to transitions of the first clock signal and the second clock signal.

10. The LCD of claim 9, wherein the first clock signal input is connected to a source or drain of the first TFT.

11. The LCD panel of claim 9, wherein the first clock signal has a first high potential and a first low potential, the second clock signal has a second high potential and a second low potential, and the first and second clock signals have the same duty cycle.

12. The LCD of claim 11, wherein within a period, the transition of the first clock signal from the first high potential to the first low potential, and the transition of the second clock signal from the second low potential to the second high potential; or the transition of the first clock signal from the first low potential to the first high potential, and the transition of the second clock signal from the second high potential to the second low potential.

13. The LCD of claim 9, wherein the driving circuit of the LCD panel further comprises a second TFT, a third TFT, and a fourth TFT, and the second, third, and fourth TFTs, all of which are connected to the controlling terminal.
